(19) United States
(12) Patent Application Publication
(10) Pub. No.: US 2026/0016676 A1
(43) Pub. Date: Jan. 15, 2026

(54) METHOD AND SYSTEM FOR MANAGING IN REAL TIME DIGITAL IMAGES GENERATED BY A DIGITAL OPTICAL PLATFORM

(71) Applicant: NTP NANO TECH PROJECTS S.R.L., Rovereto (Trento) (IT)

(72) Inventors: LIRON PANTANOWITZ, Rovereta (Trento) (IT); GIANLUCA MARONCELLI, Rovereto (Trento) (IT); MAURO ANDREA MALAN, Rovereto (Trento) (IT); MASSIMO GALAVOTTI, Rovereto (Trento) (IT); ADOLFO CARLONI, Rovereto (Trento) (IT)

(21) Appl. No.: 18/881,197

(22) PCT Filed: Jul. 17, 2023
(86) PCT No.: PCT/IB2023/057258

§ 371 Date: Jan. 3, 2025

(30) Foreign Application Priority Data
Jul. 19, 2022 (IT) 102022000015114

(51) Int. Cl. G02B 21/36; G02B 21/00; G02B 21/06

(52) U.S. Cl. CPC G02B 21/365; G02B 21/006; G02B 21/06

(57) ABSTRACT

A method for acquiring and transmitting in real time digital images of a sample to be examined placed at an acquisition workstation to an analysis workstation, includes sending, by a remote electronic control unit upon a command of an operator/doctor in the analysis workstation, an acquisition start signal of digital images of the sample, to the electronic acquisition unit to acquire digital images of the sample. Digital images are acquired by the electronic acquisition unit of the digital optical microscope. The acquired digital image is transmitted from the electronic acquisition unit to the remote electronic control unit. The acquired digital image is displayed in the analysis workstation by an electronic control unit display. The operator/doctor selects images containing representative information for analysis of the sample, from the acquired digital images. Selected images are stored in a storage of the remote electronic control unit in the analysis workstation.

### FIELD OF THE INVENTION

The present invention relates to the field of microscopic analysis, in particular to the medical field of tissue analysis and histopathological diagnosis.

### BACKGROUND ART

In the field of digital pathology, instruments capable of displaying histological samples placed on top of a slide in the form of digital images are employed; in particular, digital optical microscopes or scanners provide high-resolution images of the entire slide including different scanning planes of the preparation: the digital images thus produced with this technology are large files and require computers with high computational and memory characteristics and digital archives with sufficient space in which the information is deposited and from which the doctor can retrieve it remotely. In general, this results in a non-negligible operating time for the doctor who must carry out the diagnosis, which is certainly not suitable in the case of emergency activities.

Moreover, the huge amount of data, often of the order of tens of GB required to scan various positions of the sample, makes it impossible to transmit the data to a remote analysis workstation in real time, thus preventing remote operation.

Therefore, the need is felt to provide a method to manage digital image acquisition in real time by means of a digital optical microscope from a workstation remote from the microscope itself.

In other words, the need is felt to display what the microscope sees quickly and remotely and vary the acquisition parameters new remotely and perform acquisitions quickly, as well as to process the acquired images in real time, from a remote workstation.

The difficulties in performing such activities remotely by means of a polarizing digital optical microscope multiply.

Indeed, the polarizing digital optical microscope uses polarized light to study the samples, unlike conventional optical microscopes which use normal light.

In polarized light, light waves vibrate in a given direction, while under normal light conditions, light waves vibrate in random directions.

Polarized light cannot be seen by human eyes under normal circumstances, but it can be used in polarized light microscopy to highlight the characteristics of minerals, crystals, and other materials.

Indeed, a polarizing microscope uses the birefringent optical properties of anisotropic materials to study them.

Unlike isotropic materials (such as gases and liquids), which have only one refractive index, anisotropic materials are solid substances having different refractive indices. For example, birefringence or double refraction occurs when a light wave passing through an anisotropic material is split into two beams of different velocities.

In practice, the sample to be studied is placed on a slide above a sample-holder table. The sample is then illuminated by a light source placed under the sample table.

The light passes through a polarizing filter, referred to as a polarizer, and then passes through the birefringent sample. The polarizer is usually fixed in an East-West vibration direction but it can be rotated as needed.

A polarizing microscope comprises another polarizing filter, referred to as an analyzer, which is usually located above the targets, before the eyepiece or camera, in the case of digital image acquisition, and can be moved in and out of the optical path.

The presence of an analyzer, i.e., another polarizing filter placed between the lens and the eyepiece/camera, and the activation thereof simultaneously with the polarizing filter lead to the so-called quenching condition, i.e., the cancellation of the incident light beam, due to the perpendicular polarizing action of the analyzer with respect to the polarizer.

Indeed, the characteristics generally defining a linear polarizer are the transmission and absorption capabilities thereof.

A transmission axis, which often varies based on the polarizer grade, is what determines how much light can pass through. The absorbing axis does not allow the light to pass through the barrier.

It is then possible to use two polarizers at 90° angles to each other so that the light does not pass through to the other side.

Given the requirement for the relative phase shift characteristic between the two polarizers, the two moving mechanisms associated therewith can also be reversed, making the analyzer rotatable instead of the filter. The lenses used in a polarizing microscope must be free of deformations.

Most crystalline and mineral materials, such as those also contained in organic tissues, are capable of changing the polarized light directions, allowing some of the light to pass from the analyzer to the eyepieces/camera.

Using only one polarizer, it is possible to display the slide under the so-called “flat polarized” light. Using the two polarizers, analysis is possible in the so-called “cross-polarized” light mode, for example by holding the polarizing filter still and rotating the analyzer about the axis thereof.

Using the linear polarization, depending on the angle of the polarizer, the light can be directed at a given angle to different positions with respect to the object. Hence, the device can be used to minimize reflections, control light intensity, or eliminate light in order to make colors more vibrant. Various types of linear polarizers are available, including dichroic, reflection, double-refraction, and beam-splitting polarizers.

Hence, it can be understood how the technical difficulty of implementing the polarizer in digital solutions with scanner technology lies in the huge data load involved in the preliminary scanning operation of the single slide (of the order of tens of GBs to scan at various heights of the sample), to which the data generated for each frame of the slide as the mutual angle between the polarizer elements changes should thus be added.

For example, assuming that, for each frame, the acquisition of the polarizer effect at a rotation arc of 25° is desired, this would result in the management of a huge data load, over 1,000 GB, for a single slide (we are on the order of one Terabyte). In short, this is de facto impractical.

Therefore, a need is felt to manage a digital optical microscope from a remote workstation and vary the parameters thereof during remote observation, thus avoiding the need to transmit huge amounts of data from the acquisition workstation to the analysis workstation.

### SUMMARY OF THE INVENTION

It is the object of the present invention to devise and provide a method and a system which allow meeting the aforesaid needs and at least partially obviating the drawbacks complained above with reference to the prior art.

In particular, it is a task of the present invention to provide a method and system which allow the operator at the remote analysis workstation to interact with the microscope in the acquisition workstation, continuously in live view, without ever disengaging from the field of view, allowing the operator to select the representative images for analysis while displaying the video stream in real time.

It is another object of the present invention to provide a method and a system which allow quickly and remotely displaying what the microscope sees and varying the acquisition parameters remotely, in addition to quickly performing new acquisitions, as well as processing the acquired images in real time, from a remote workstation.

It is a further object of the present invention to provide a method and a system which allow managing a digital optical microscope from a remote workstation, and varying the parameters thereof during remote observation, thus avoiding the need to transmit huge amounts of data from the acquisition to workstation the analysis workstation.

These and other objects and advantages are achieved by a method and a system according to the independent claims.

Advantageously, the method according to the invention allows the operator, who is at a remote workstation with respect to the microscope, to operate in live-view with the microscope, employing a live streaming technique, always in live stream with the sample, always engaged with the field of view offered by the camera of the microscope at the instant of observation, and any possible change in the field of view occurs live, allowing the remote operator to act on the sample moving devices on the microscope and display remotely at the same time. Therefore, the remote operator is able to interact continuously and directly with the observed object, operating remotely on the microscope components.
In other words, the method according to the invention uses a continuous video stream and allows the operator, while remotely displaying the continuous stream in real time, to interact with the microscope, select the images of interest while displaying the video stream in real time, and store only these on the remote workstation.

Further objects, solutions, and advantages are present in the embodiments described below and claimed in the dependent claims.

### BRIEF DESCRIPTION OF THE DRAWINGS

The invention will be shown below through the description of some embodiments thereof, given by way of non-limiting example, with reference to the accompanying drawings, in which:

FIG. 1 shows a block diagram illustrating the method for acquiring and transmitting in real time digital images of a sample to be examined placed at a remote acquisition workstation to an analysis workstation, according to the invention;

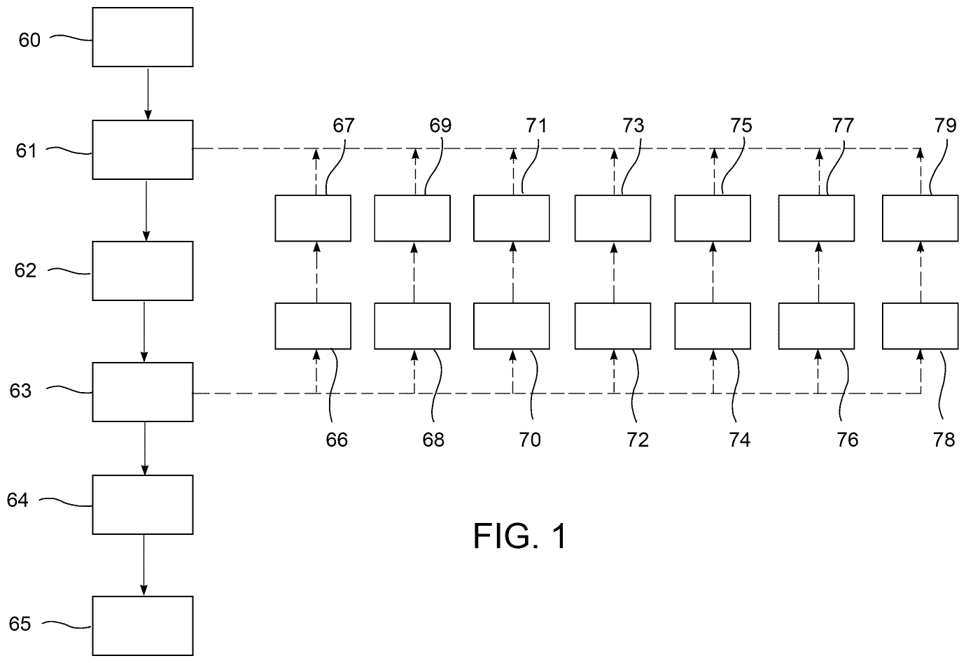

FIG. 2 shows a block diagram illustrating a digital image acquisition system according to the invention;

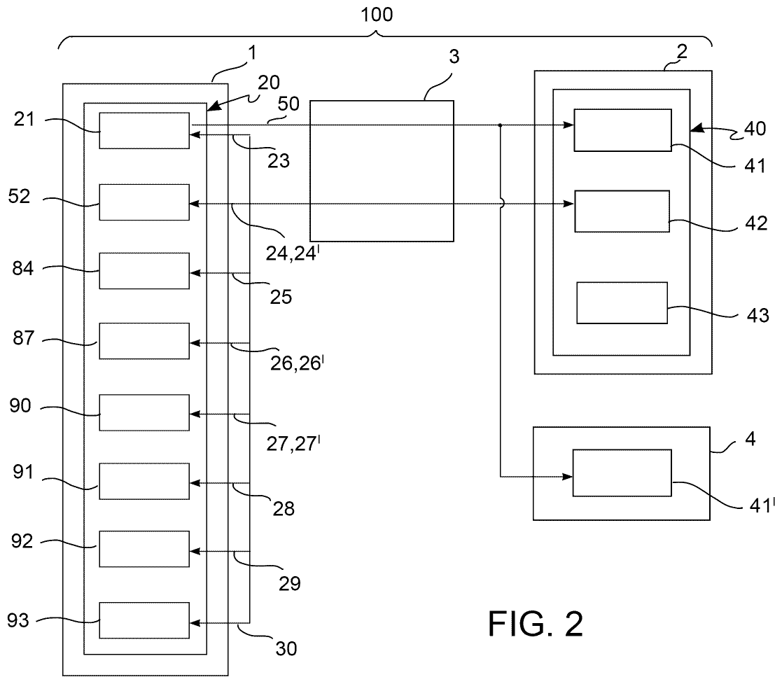

FIG. 3 shows a partial diagrammatic view of a digital optical microscope of the digital image acquisition system of the system in FIG. 2.

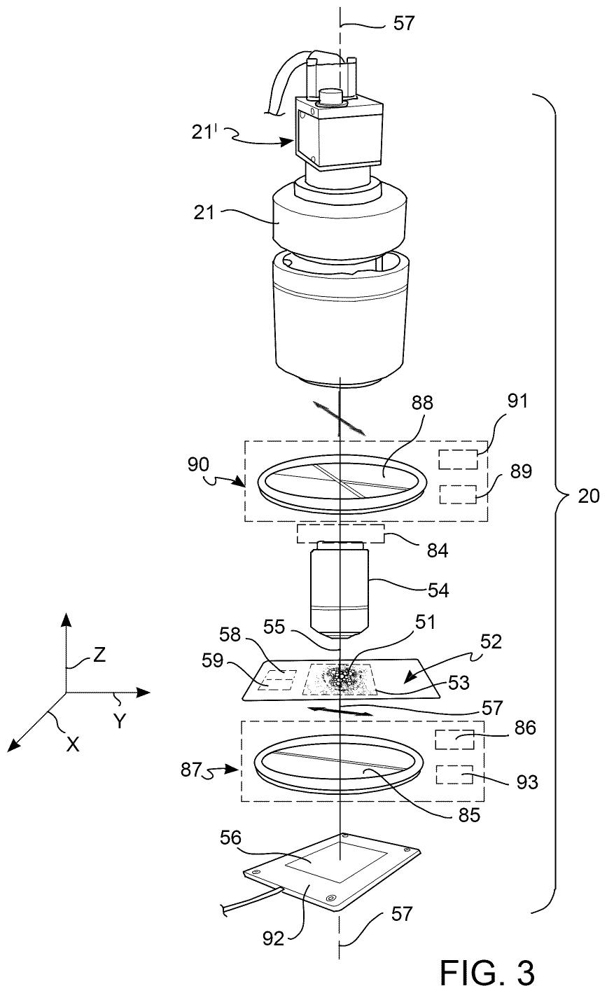

### DESCRIPTION OF PREFERRED EMBODIMENTS

A method according to the invention for acquiring and transmitting in real time digital images 50, in particular a plurality of digital images 50 in sequence or, in other words, a video stream 50, of a sample to be examined 51 from an acquisition workstation 1 to an analysis workstation 2 is illustrated with reference to the figures.

The sample to be examined 51 is placed in the acquisition workstation 1, whereas the analysis workstation 2 is remote from the acquisition workstation 1.

The plurality of digital images 50 in sequence, in particular the video stream, are generated by a digital image acquisition system 100.

The digital image acquisition system 100 comprises a digital optical microscope 20 placed in said acquisition workstation 1, said microscope 20 having an electronic acquisition unit 21 of one or more digital images, in particular a plurality of images 50 in sequence, or a video stream, of said sample to be examined 51 comprising a digital optical sensor 21′, a sample-holder table 52 having a seat 53 for a sample adapted to accommodate or support said sample to be examined 51, an optical lens 54 associable with said acquisition unit 21 and defining a lens optical axis 55 and a lens focal point, a light source 56 oriented toward said seat 53 for a sample to illuminate said sample to be examined 51, said digital optical microscope 20 defining a microscope optical axis 57 passing through said digital optical sensor and said seat 53 for a sample, coaxial with said lens optical axis 55 in use.

Focal point of a lens means the point placed along the optical axis where the lens is capable of reconstructing a perfectly focused image. The optical sensor must be located at this point.

The digital image acquisition system 100 further comprises a remote electronic control unit 40 of said digital optical microscope placed in said analysis workstation 2, said remote electronic control unit 40 comprising display means 41 to display said one or more digital images 50, or said plurality of digital images 50 in sequence, or said video stream, of said sample to be examined, command means 42, and storage means 43.

The digital image acquisition system 100 further comprises signal communication means 3 configured to connect said remote electronic control unit 40 to said electronic acquisition unit 21 of one or more digital images, or of said plurality of digital images in sequence, or said video stream.

The aforesaid method of acquiring and transmitting digital images 50 in real time comprises the following steps:

sending (60), by said remote electronic control unit 40 upon a command of an operator, or a doctor, in said analysis workstation 2, an acquisition start signal 23 of one or more digital images, in particular a plurality of digital images 50 in sequence, or a video stream, of the sample to be examined, to the electronic acquisition unit 21 to acquire one or more digital images 50, in particular a plurality of digital images in sequence, or a video stream, of the sample to be examined;
acquiring (61) one or more digital images 50, in particular a plurality of digital images in sequence, or a video stream, by said electronic acquisition unit 21 of the digital optical microscope 20;
transmitting (62) in real time said one or more digital image 50, or each image of said plurality of digital images 50 in sequence, or said video stream, from said electronic acquisition unit 21 to said remote electronic control unit 40 by means of said communication means 3;
displaying (63) in real time, preferably in live-view mode, said at least one acquired digital image 50, or each image of said plurality of digital images 50 in sequence, or said video stream, in said analysis workstation 2 by means of said display means 41 of said electronic control unit 40;
selecting (64), by said operator, or doctor, by means of said command means 42 in said analysis workstation 2, one or more images containing representative information for the analysis of said sample, from said one or more acquired digital images 50, or from said plurality of images 50 in sequence, or said video stream, during the displaying step (63);
storing (65) said one or more selected images by means of said storage means 43 of said remote electronic control unit 40 in said analysis workstation 2.

According to an embodiment, said digital optical microscope 20 comprises a motorized sample-holder table moving unit 58 configured to move said sample-holder table 52 along two movement axes X, Y orthogonal to each other and orthogonal to said microscope optical axis 57, where the digital signal communication means 3 are configured to connect said remote electronic control unit 40 to said motorized sample-holder table moving unit 58.

According to an embodiment, the method comprises the steps of: sending (66), by said remote electronic control unit 40 to said sample-holder table moving unit 58, a table movement signal 24, upon a command of the operator, or doctor, by means of said command means 42 preferably during said displaying step (63), and moving said sample-holder table along said two movement axes X, Y by means of said sample-holder table movement unit as a function of said table movement signal 24.

According to an embodiment, the digital optical microscope comprises a motorized focus distance adjustment unit 59 for adjusting the relative distance between said lens focal point and said seat 53 for a sample measured along an adjustment axis Z parallel to said microscope optical axis 57, and the digital signal communication means 3 are configured to connect said remote electronic control unit 40 to said motorized focus distance adjustment unit 59.

According to an embodiment, the method comprises the steps of: sending (68), by said remote electronic control unit 40 to said motorized focus distance adjustment 59, a focus distance adjustment signal 24′, upon a command of the operator, or doctor, by means of said command means 42, preferably during said displaying step (63); and moving said sample-holder table 52 and/or said optical lens 54 along said adjustment axis Z by means of said motorized focus distance adjustment unit 59, as a function of said adjustment signal 24′.

Moving the sample-holder table 52 close to or away from the optical lens 54 along the Z direction, preferably along the microscope optical axis 57, implements the function of enlarging or reducing the field of view, and thus allows implementing the zoom function.

According to an embodiment, the digital optical microscope 20 comprises a motorized lens changing unit 84 comprising a plurality of lenses having respective mutually different focal lengths, where said motorized lens changing unit 84 is configured to selectively position a selected lens 54 of said plurality so that the optical axis of said selected lens 55 is positioned along said microscope optical axis 57, where the digital signal communication means 3 are configured to connect said remote electronic control unit 40 to said motorized lens changing unit 84.

According to an embodiment, the method comprises the steps of: sending (70), by said remote electronic control unit 40 to said motorized lens changing unit 84, a lens changing signal 25, upon a command of the operator, or doctor, by means of said command means 42, preferably during said displaying step (63); arranging said selected lens 54 with said lens optical axis 55 along said microscope optical axis 57 by means of said motorized lens changing unit 84 as a function of said lens changing signal 25.

According to an embodiment, the digital optical microscope 20 comprises a first polarizing unit 87 comprising a first polarizing filter 85 and a first motorized activation/deactivation moving unit 86 for moving said first polarizing filter 85 from a resting position not arranged along said microscope optical axis 57 to an operating position interposed between said light source 56 and said sample-holder table 52 along said microscope optical axis 57, and vice versa; and where said digital signal communication means 3 are configured to connect said remote electronic control unit 40 to said first motorized activation/deactivation moving unit 86.

According to an embodiment, the method comprises the steps of: (72), by said remote electronic control unit 40 to said first motorized activation/deactivation moving unit 86 upon a command of the operator, or doctor, a first polarizing unit activation signal 26, preferably during said displaying step (63), and a step of moving (73) said first polarizing filter 85 from said resting position to said operating position, by means of said first motorized activation/deactivation moving unit 86, as a function of said first polarizing unit activation signal 26.

According to an embodiment, the method comprises the steps of: sending (72), by said remote electronic control unit 40 to said first motorized activation/deactivation moving unit 86 upon a command of said operator, or doctor, a first polarizing unit activation signal 26′ preferably during said displaying step (63); moving (73) said first polarizing filter 85 from said resting position to said operating position, by means first motorized activation/deactivation moving unit 86, as a function of said first polarizing unit activation signal 26′.

According to an embodiment, said digital optical microscope 20 comprises an analyzer polarizing unit 90 comprising an analyzer polarizing filter 88 and a motorized analyzer activation/deactivation moving unit 89 for moving said analyzer polarizing filter 88 from a resting position not arranged along said microscope optical axis 57 to an operating position interposed between the digital optical sensor 21′ and said optical lens 54 along said microscope optical axis 57, and vice versa.

According to an embodiment, the digital signal communication means 3 are further configured to connect said remote electronic control unit 40 to said motorized analyzer activation/deactivation moving unit 89.

According to an embodiment, the method comprises the steps of: sending (74), by said remote electronic control unit 40 to said analyzer polarizing unit 90 upon a command of said operator, or doctor, an analyzer polarizing unit activation signal 27 preferably during said displaying step; and moving (75) said analyzer polarizing filter 88 from said resting position to said operating position, by means of said analyzer activation/deactivation moving unit 89, as a function of said analyzer polarizing unit activation signal 27.

According to an embodiment, the method comprises a step of sending (74), by said remote electronic control unit 40 to said analyzer polarizing unit 90 upon a command of said operator, or doctor, an analyzer polarizing unit deactivation signal 27, preferably during said displaying step (63)′.

According to an embodiment, the method comprises a step of moving (75) said analyzer polarizing filter 88 from said operating position to said resting position, by means of said analyzer activation/deactivation moving unit 89 as a function of said analyzer polarizing unit deactivation signal 27′.

According to an embodiment, the analyzer polarizing unit 90 comprises a motorized rotational adjustment unit 91 to adjust the angular position of said analyzer polarizing filter 88 about a rotational axis of said analyzer polarizing filter arranged along said microscope optical axis 57, and said digital signal communication means 3 are further configured to connect said remote electronic control unit 40 to said motorized rotational adjustment unit 91.

According to an embodiment, the method comprises the steps of: sending (76), by said remote electronic control unit 40 to said analyzer polarizing unit 90 upon a command of the operator, or doctor, a rotation signal 28 of said analyzer polarizing filter, preferably during said displaying step (63); and rotating 77 said analyzer polarizing filter 88, by means of said motorized rotational adjustment unit 91, as a function of said rotation signal 28 of said analyzer polarizing filter.

According to another embodiment, said first polarizing unit 87 comprises a motorized polarizer rotational adjustment unit 93 configured to adjust the angular position of said first polarizing filter 85 about a rotational axis arranged along said microscope optical axis 57, and where said digital signal communication means 3 are further configured to connect said remote electronic control unit 40 to said motorized polarizer rotational adjustment unit 93.

According to an embodiment, the method comprises the steps of: sending, by said remote electronic control unit 40 to said analyzer polarizing unit 87 upon a command of the operator, or doctor, a rotation signal 30 of said polarizing filter 85, preferably during said displaying step; and rotating said polarizing filter 85, by means of said motorized polarizer rotational adjustment unit 93, as a function of said rotation signal 30 of said polarizing filter 85.

In other words, for certain applications, the digital optical microscope can comprise both a motorized rotational adjustment unit 93 of the polarizing filter 85 and a motorized rotational adjustment unit 92 of the analyzer polarizing filter 88 to adjust them both in relative rotation to each other, or, in other applications, it can comprise only a rotational adjustment unit of the polarizing filter 85 and not comprise a rotational adjustment unit of the analyzer polarizing filter 88. The electronic remote control unit 40 can thus be configured to control, upon a command of the doctor, the relative rotation of the polarizing filter 85 and the analyzer polarizing filter 88 in a coordinated and/or simultaneous manner, in order to polarize the light passing through each of them in a combined manner, for example.

According to an embodiment, the digital optical microscope 20 comprises a light intensity adjustment unit 92 of said light source 56, and where said digital signal communication means 3 are configured to connect said remote electronic control unit 40 to said light intensity adjustment unit 92.

According to an embodiment, the method comprises the steps of: sending (78), by said remote electronic control unit 40 to said analyzer polarizing unit 92 upon a command of the operator, or doctor, a light intensity adjustment signal 29, preferably during said displaying step (63); and adjusting (79) the light intensity of said light source 56, by means of said light intensity adjustment unit 92, as a function of said light intensity adjustment signal 29.

According to an embodiment, the method comprises a step of transmitting in real time said digital images 50, or said plurality of images in sequence, or said video stream, to at least one remote display-only workstation 4, following a doctor's command provided to said remote electronic control unit 40 by means of said command means 42.

The at least one display-only workstation 4, used by a user in “viewer” mode, only allows displaying in real time the same digital images shown to the doctor by means of the display means 41 of the remote electronic control unit 40, with no possibility of command by the user in the “viewer” mode.

The aforesaid remote display-only workstation can comprise a monitor or digital display 41′, e.g., a LED panel, or a projector, or can comprise a personal computer equipped with said monitor 41′, or a portable electronic device equipped with an electronic display, e.g., a smartphone, tablet, laptop, etc.

The user in the “viewer” mode is only allowed the function of displaying images. Indeed, the user in the “viewer” mode, is the one who, positioned remotely from the microscope, is only able to display the images, which continue to be managed and shared by the doctor, who thus performs the function of operator in the “master” mode of the session, residing at the analysis station 2, which is located remotely from the acquisition workstation 1.

The use of the at least one display-only workstation 4 is suitable, for example, for the educational use of the system, e.g., users in the “viewer” mode could be students at a university lecture, each being in a respective remote location, and in which the doctor placed in the analysis workstation is the lecturer.

The doctor, who interacts in the “master” mode with the remote control unit 40 by means of the command means 42, can manage the digital images by performing, for example, shifts, zooms, changes in brightness level, and the users in the “viewer” mode can simultaneously remotely follow such a management by the doctor.

The method described above thus allows digital images to be managed in real time, in particular in live-view mode, and even in the function with the polarizer, is easily employable under the direct control of the remotely seated pathologist, thus allowing the diagnosis of specific cases of tissues with elements sensitive to the polarization effect (presence of crystals in certain organs, amyloidosis, etc.).

Indeed, in the case of digital pathology, the produced image is acquired by a camera, managed by a computational unit, and made available in real time on a terminal, e.g., the PC monitor or any end-user device. Moreover, the two polarizers are moved by electric motors and controlled by means of software. The end result is that the doctor can view live, remotely by means of the data network, the sample placed on the slide, and also collect information therefrom resulting from the appropriate use of polarized light.

According to another aspect of the present invention, the aforesaid object and advantages are achieved by a digital image acquisition system 100 comprising a digital optical microscope 20 placed in an acquisition workstation 1, comprising an electronic acquisition unit 21 of one or more digital images, or in other words, a plurality of digital images in sequence, or a video stream, of a sample to be analyzed 51 comprising a digital optical sensor 21′, a sample-holder table 52 having a seat 53 for a sample adapted to accommodate or support said sample to be examined 51, an optical lens 54 associable with said acquisition unit 21 and defining a lens optical axis 55 and a lens focal point, a light source 56 oriented toward said seat 53 for a sample to illuminate said sample to be examined 51, said digital optical microscope 20 defining a microscope optical axis 57 passing through said digital optical sensor 21′ and said seat 53 for a sample, coaxial with said lens optical axis 55 in use.

The digital image acquisition system 100 further comprises a remote electronic control unit 40 of said digital optical microscope 20 located in an analysis workstation 2 remote from said acquisition workstation 1, said remote electronic control unit 40 comprising display means 41 to allow an operator, or a doctor, to display in real time, preferably in live-view mode, said one or more digital images 50, or said plurality of images in sequence, or said video stream, of said sample to be examined 51, in said analysis workstation 2, and command means 42 operable by said operator, or doctor, in said analysis workstation 2 to select one or more images containing representative information for analyzing said sample, from said one or more acquired digital image 50, or in other words, from said plurality of digital images in sequence, or said video stream, during the real-time display, said remote electronic control unit 40 of said digital optical microscope further comprising storage means 43 for storing said one or more selected digital images.

Indeed, the digital image acquisition system 100 further comprises digital signal communication means 3 configured to connect said remote electronic control unit 40 to said electronic image acquisition unit 21 of the digital optical microscope 20.

According to an embodiment, the digital optical microscope 20 comprises a motorized sample-holder table moving unit 58 configured to move said sample-holder table 52 along two movement axes X, Y orthogonal to each other and orthogonal to said microscope optical axis 57, and where the digital signal communication means 3 are configured to connect said remote electronic control unit 40 to said motorized sample-holder table moving unit 58.

According to an embodiment, the digital optical microscope 20 comprises a focus distance adjustment unit 59 for adjusting the relative distance between said lens focal point and said seat 53 for a sample measured along an adjustment axis Z parallel to said microscope optical axis 57, and where said digital signal communication means 3 are configured to connect said remote electronic control unit 40 to said motorized focus distance adjustment unit 59.

According to an embodiment, the digital optical microscope 20 comprises a motorized lens changing unit 84 comprising a plurality of lenses having respective mutually different focal lengths, where said motorized lens changing unit 84 is configured to selectively position a selected lens 54 of said plurality so that the optical axis of said selected lens 54 is positioned along said microscope optical axis 57, and where said digital signal communication means 3 are configured to connect said remote electronic control unit 40 to said motorized lens changing unit 84.

According to an embodiment, the digital optical microscope 20 comprises a first polarizing unit 87 comprising a first polarizing filter 87 and a first motorized activation/deactivation moving unit 86 for moving said first polarizing filter 85 from a resting position not arranged along said microscope optical axis 57 to an operating position interposed between said light source 56 and said sample-holder table 52 along said microscope optical axis 57, and vice versa; and where said digital signal communication means 3 are configured to connect said remote electronic control unit 40 to said first motorized activation/deactivation moving unit 86.

According to an embodiment, the digital optical microscope 20 comprises an analyzer polarizing unit 90 comprising an analyzer polarizing filter 88 and a motorized analyzer activation/deactivation moving unit 89 for moving said analyzer polarizing filter 88 from a resting position not arranged along said microscope optical axis 57 to an operating position interposed between said digital optical sensor 21′ and said optical lens 54 along said microscope optical axis 57, and vice versa; and where said digital signal communication means 3 are further configured to connect said remote electronic control unit 40 to said motorized analyzer activation/deactivation moving unit 89.

According to an embodiment, said analyzer polarizing unit 90 comprises a motorized rotational adjustment unit 91 for adjusting the angular position of said analyzer polarizing filter 88 about a rotational axis of said analyzer polarizing filter 88 arranged along said microscope optical axis 57; and where said digital signal communication means 3 are further configured to connect said remote electronic control unit 40 to said motorized rotational adjustment unit 91.

According to an embodiment, the digital optical microscope 20 comprises a light intensity adjustment unit 92 of said light source 56, and where said digital signal communication means 3 are configured to connect said remote electronic control unit 40 to said light intensity adjustment unit 92.

According to an embodiment, the remote control unit 40 is configured to allow said operator, or doctor, to draw one or more lines and/or one or more marks on said selected image, by means of said command means 42.

Those skilled in the art may make changes and adaptations to the embodiments of the device described above or can replace elements with others which are functionally equivalent in order to meet contingent needs without departing from the scope of the appended claims. Each of the features described as belonging to a possible embodiment can be implemented irrespective of the other embodiments described.

All features described herein and/or any step of the method described herein can be combined in any combination, even excluding parts thereof, except for the combinations in which at least some of such features and/or steps mutually exclude one another.

1. A method for acquiring and transmitting in real time digital images of a sample to be examined placed at an acquisition workstation to an analysis workstation, said analysis workstation being remote from said acquisition workstation, said digital images being generated by a digital image acquisition system that comprises:
a digital optical microscope placed in said acquisition workstation, said microscope having an electronic acquisition unit of one or more digital images of said sample to be examined comprising a digital optical sensor, a sample-holder table having a seat for a sample adapted to accommodate or support said sample to be examined, an optical lens associable with said acquisition unit and defining a lens optical axis and a lens focal point, a light source oriented toward said seat for a sample to illuminate said sample to be examined, said digital optical microscope defining a microscope optical axis passing through said digital optical sensor and said seat for a sample, coaxial with said lens optical axis in use;
a remote electronic control unit of said digital optical microscope placed in said analysis workstation, said remote electronic control unit comprising: display means to display said one or more digital images of said sample to be examined, command means, and storage means;
digital signal communication means configured to connect said remote electronic control unit to said electronic acquisition unit of one or more digital images, the method comprising the steps of:
sending, by said remote electronic control unit upon a command of an operator, or a doctor, in said analysis workstation, an acquisition start signal of one or more digital images of the sample to be examined, to the electronic acquisition unit to acquire one or more digital images of the sample to be examined;
acquiring one or more digital images by said electronic acquisition unit of the digital optical microscope;
transmitting said one or more acquired digital image from said electronic acquisition unit to said remote electronic control unit by means of said communication means,
displaying said at least one acquired digital image in said analysis workstation by means of said display means of said electronic control unit;
selecting, by said operator, or doctor, by means of said command means in said analysis workstation, one or more images containing representative information for the analysis of said sample, from said one or more acquired digital images;
storing said one or more selected images, by means of said storage means of said remote electronic control unit in said analysis workstation.

2. The method according to claim 1, wherein:
said digital optical microscope comprises a motorized sample-holder table moving unit configured to move said sample-holder table along two movement axes orthogonal to each other and orthogonal to said microscope optical axis, and wherein
said digital signal communication means are configured to connect said remote electronic control unit to said motorized sample-holder table moving unit
the method comprising the steps of:
sending, by said remote electronic control unit to said sample-holder table moving unit, a table movement signal, upon a command of the operator, or doctor, provided by means of said command means;
moving said sample-holder table along said two movement axes by said sample-holder table movement as a function of said table movement signal.

3. The method according to claim 1, wherein:
said digital optical microscope comprises a motorized focus distance adjustment unit to adjust the a relative distance between said lens focal point and said seat for a sample measured along an adjustment axis parallel to said microscope optical axis; wherein
said digital signal communication means are configured to connect said remote electronic control unit to said motorized focus distance adjustment unit; the method comprising the steps of:
sending, by said remote electronic control unit to said motorized focus distance adjustment unit a focus distance adjustment signal, upon a command of the operator, or doctor, provided by means of said command means;
moving said sample-holder table, and/or said optical lens along said adjustment axis by said motorized focus distance adjustment unit, as a function of said adjustment signal.

4. The method according to claim 1, wherein:
said digital optical microscope comprises a motorized lens changing unit comprising a plurality of lenses having respective mutually different focal lengths, wherein said motorized lens changing unit is configured to selectively position a selected lens of said plurality of lenses so that an optical axis of said selected lens is positioned along said microscope optical axis, wherein said digital signal communication means are configured to connect said remote electronic control unit to said motorized lens changing unit;
the method comprising the steps of:
sending, by said remote electronic control unit to said motorized lens changing unit a lens changing signal, upon a command of the operator, or doctor, by said command means;
arranging said selected lens with said lens optical axis along said microscope optical axis by said motorized lens changing unit as a function of said lens changing signal.

5. The method according to claim 1, wherein:
said digital optical microscope comprises a first polarizing unit comprising a first polarizing filter and a first motorized activation/deactivation moving unit for moving said first polarizing filter from a resting position not arranged along said microscope optical axis to an operating position interposed between said light source and said sample-holder table along said microscope optical axis, and vice versa;
and wherein
said digital signal communication means are configured to connect said remote electronic control unit to said first motorized activation/deactivation moving unit;
the method comprising the steps of:
sending, by said remote electronic control unit to said first motorized activation/deactivation moving unit upon a command of the operator, or doctor, a first polarizing unit activation signal;
moving said first polarizing filter from said resting position to said operating position, by said first motorized activation/deactivation moving unit, as a function of said first polarizing unit activation signal, or
sending, by said remote electronic control unit to said first motorized activation/deactivation moving unit upon a command of said operator, or doctor, a first polarizing unit deactivation signal;
moving said first polarizing filter from said operating position to said resting position, by said first motorized activation/deactivation moving unit, as a function of said first polarizing unit deactivation signal.

6. The method according to claim 1, wherein:
said digital optical microscope comprises an analyzer polarizing unit comprising an analyzer polarizing filter and a motorized analyzer activation/deactivation moving unit for moving said analyzer polarizing filter from a resting position not arranged along said microscope optical axis to an operating position interposed between the digital optical sensor and said optical lens along said microscope optical axis, and vice versa;
and wherein
said digital signal communication means are further configured to connect said remote electronic control unit to said motorized analyzer activation/deactivation moving unit;
the method comprising the steps of:
sending, by said remote electronic control unit to said analyzer polarizing unit upon a command of said operator, or doctor, an analyzer polarizing unit activation signal;
moving said analyzer polarizing filter from said resting position to said operating position, by means of said analyzer activation/deactivation moving unit, as a function of said analyzer polarizing unit activation signal, or
sending, by said remote electronic control unit to said analyzer polarizing unit upon a command of said operator, or doctor, an analyzer polarizing unit deactivation signal;
moving said analyzer polarizing filter from said operating position to said resting position, by said analyzer activation/deactivation moving unit, as a function of said analyzer polarizing unit deactivation signal.

7. The method according to claim 6, wherein:
said analyzer polarizing unit comprises a motorized rotational adjustment unit to adjust the angular position of said analyzer polarizing filter about a rotational axis of said analyzer polarizing filter arranged along said microscope optical axis;
said digital signal communication means are further configured to connect said remote electronic control unit to said motorized rotation adjustment unit;
the method comprising the steps of:
sending, by said remote electronic control unit to said analyzer polarizing unit upon a command of the operator, or doctor, a rotation signal of said analyzer polarizing filter;
rotating said analyzer polarizing filter, by said motorized rotational adjustment unit, as a function of said rotation signal of said analyzer polarizing filter.

8. The method according to claim 1 wherein said digital optical microscope comprises a light intensity adjustment unit of said light source, and wherein said digital signal communication means are configured to connect said remote electronic control unit to said light intensity adjustment unit;
the method comprising the steps of:
sending, by said remote electronic control unit to said light intensity control unit, upon a command of the operator, or doctor, a light intensity adjustment signal;
adjusting the light intensity of said light source, by said light intensity adjustment unit, as a function of said light intensity rotation signal.

9. The method according to claim 1, comprising a step of transmitting in real time said digital images to one or more remote display-only workstations, following a doctor's command provided to said remote electronic control unit by said command means.

10. A digital image acquisition system comprising:
a digital optical microscope placed in an acquisition workstation comprising an electronic acquisition unit of one or more digital images of a sample to be examined comprising a digital optical sensor, a sample-holder table having a sample housing adapted to accommodate or support said sample to be examined, an optical lens associable with said acquisition unit and defining a lens optical axis and a lens focal point, a light source oriented toward said sample housing to illuminate said sample to be examined, said digital optical microscope defining a microscope optical axis passing through said digital optical sensor and said seat for a sample, coaxial with said lens optical axis in use;
a remote electronic control unit of said digital optical microscope located in an analysis workstation remote from said acquisition workstation, said remote electronic control unit comprising display means to allow an operator, or a doctor, to display said one or more digital images of said sample to be examined, in said analysis workstation, and command means operable by said operator, or doctor, in said analysis workstation to select one or more images containing representative information for analyzing said sample, from said one or more acquired digital images, said remote electronic control unit of said digital optical microscope further comprising storage means for storing said one or more selected digital images;
digital signal communication means configured to connect said remote electronic control unit to said electronic image acquisition unit of the digital optical microscope.

11. The digital image acquisition system, according to claim 10, wherein:
said digital optical microscope comprises a motorized sample-holder table moving unit configured to move said sample-holder table along two movement axes orthogonal to each other and orthogonal to said microscope optical axis, and wherein said digital signal communication means are configured to connect said remote electronic control unit to said motorized sample-holder table moving unit; and/or wherein:
said digital optical microscope comprises a motorized focus distance adjustment unit for adjusting the a relative distance between said lens focal point and said seat or a sample measured along an adjustment axis parallel to said microscope optical axis; and wherein digital signal communication means are configured to connect said remote electronic control unit to said motorized focus distance adjustment unit.

12. The digital image acquisition system according to claim 10, wherein said digital optical microscope comprises a motorized lens changing unit comprising a plurality of lenses having respective mutually different focal lengths, wherein said motorized lens changing unit is configured to selectively position a selected lens of said plurality of lenses so that an optical axis of said selected lens is positioned along said microscope optical axis, and wherein said digital signal communication means are configured to connect said remote electronic control unit to said motorized lens changing unit,

13. The digital image acquisition system according to claim 10, wherein said digital optical microscope comprises a first polarizing unit comprising a first polarizing filter and a first motorized activation/deactivation moving unit for moving said first polarizing filter from a resting position not arranged along said microscope optical axis to an operating position interposed between said light source and said sample-holder table along said microscope optical axis, and vice versa; and wherein said digital signal communication means are configured to connect said remote electronic control unit to said first motorized activation/deactivation moving unit.

14. The digital image acquisition system according to claim 10, wherein said digital optical microscope comprises an analyzer polarizing unit comprising an analyzer polarizing filter and a motorized analyzer activation/deactivation moving unit for moving said analyzer polarizing filter from a resting position not arranged along said microscope optical axis to an operating position interposed between said digital optical sensor and said optical lens along said microscope optical axis, and vice versa; and wherein said digital signal communication means are further configured to connect said remote electronic control unit to said motorized analyzer activation/deactivation moving unit.

15. The digital image acquisition system according to claim 14, wherein said analyzer polarizing unit comprises a motorized rotation adjustment unit to adjust the angular position of said analyzer polarizing filter about a rotational axis of said analyzer polarizing filter arranged along said microscope optical axis; and wherein digital signal communication means are further configured to connect said remote electronic control unit to said motorized rotation adjustment unit.

16. The digital image acquisition system according to claim 10, wherein said digital optical microscope comprises a light intensity adjustment unit of said light source, and wherein said digital signal communication means are configured to connect said remote electronic control unit to said light intensity adjustment unit.

17. The digital image acquisition system, according to claim 10, wherein said remote control unit is configured to allow said operator, or doctor, to draw on said selected image, one or more lines and/or one or more marks, by said command means.
